(19) United States
(12) Patent Application Publication
(10) Pub. No.: US 2008/0291375 A1
(43) Pub. Date: Nov. 27, 2008

(54) COLOR DISPLAY APPARATUS

(75) Inventor: Yasufumi Asao, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/122,208

(22) Filed: May 16, 2008

(30) Foreign Application Priority Data
May 24, 2007 (JP) 2007-137947

(51) Int. Cl. G02F 1/1335

(52) U.S. Cl. 349/106

(57) ABSTRACT

A color display apparatus includes a plurality of color elements, each color element including an electro-optical element in which retardation varies in accordance with a voltage applied to the electro-optical element and a color filter provided on the electro-optical element. The color elements include two or more first color elements in which the color filters transmit light of two of three primary colors, each first color element receiving a voltage that continuously varies the retardation of the electro-optical element in a range in which brightness of the first color element varies and a range which starts from the retardation corresponding to the maximum brightness and in which hue of the first color element varies between the two of the three primary colors. The two or more first color elements function as a unit of color display for the two of the three primary colors.

### BACKGROUND OF THE INVENTION

1. Field of the Invention

The present invention relates to a display apparatus capable of displaying multicolor images.

2. Description of the Related Art

Recently, the technology of electronic displays, such as liquid crystal displays, plasma displays, and organic electroluminescence displays has been rapidly developed and has come into widespread use. The electronic displays generally use a color display method in which each pixel includes three sub-pixels corresponding to three primary colors: red (R), green (G), and blue (B). The sub-pixels are arranged in parallel, and various colors are presented by spatial color mixture. Each of the sub-pixels is capable of expressing the corresponding color in various tones, and is controlled so as to provide substantially continuous gradation. Thus, a full color display can be obtained.

Many electronic displays include sub-pixels having color filters corresponding to the three RGB colors, and each of the sub-pixels provides continuous gradation. Therefore, a full color display can be presented on the basis of the principle of spatial additive color mixture.

A time-sharing color display method has been suggested as another color display method. In this method, the color of light from a light source is switched between the three RGB colors at a high frequency, and an optical modulator is controlled in synchronization with the switching between the colors. Thus, a full color display can be obtained on the basis of the principle of temporal additive color mixture. This method uses the principle of color mixture based on the afterimage effect of human eyes, unlike the spatial color mixture.

Three-panel projection display apparatuses including an optical modulator for each of the RGB colors and color display apparatuses having display panels corresponding to the RGB colors are also known. In addition, display apparatus using the principle of subtractive color mixture and having display panels corresponding to yellow (Y), magenta (M), and cyan (C) are also known.

The display methods of the above-mentioned display apparatuses are common in that the three RGB colors are displayed using three respective display elements.

In comparison, US Unexamined Patent Application Publication No. 2006/0055713 discusses a hybrid color display method, which is different from the above-described known display methods. In the hybrid color display method, an axis of one of the three primary colors is individually controlled, whereas axes of the other two primary colors are expressed by a single display element.

The above-mentioned document suggests a hybrid color reflective liquid crystal display (hereinafter abbreviated as HC-LCD), which is a reflective color liquid crystal display using birefringence of liquid crystal.

FIG. 13 is a sectional view of a single pixel in the HC-LCD. The single pixel includes a sub-pixel (hereinafter called a sub-pixel 1) having a magenta color filter and a sub-pixel (hereinafter called a sub-pixel 2) having a green color filter.

In the HC-LCD, the green sub-pixel is controlled by the known method. Therefore, green can be displayed in any halftone. However, red and blue are displayed using birefringence and cannot be displayed with intermediate brightness.

Japanese Patent Laid-Open No. 06-095151 describes a multi-color display method using an electrically controlled birefringence (ECB) color display. In this method, a plurality of sub-pixels having different colors are used in combination. For example, dark red is displayed by setting one of two sub-pixels to red and the other to black, and light blue is displayed by setting one of two sub-pixels to blue and the other to white.

Colors that can be displayed by the HC-LCD are described in detail in Proceedings of the Society for Information Display '04 (SID'04) p. 1110.

A method for increasing the number of colors on the RB plane by combining a plurality of pixels instead of dividing each pixel is disclosed in US Unexamined Patent Application Publication No. 2006/0017750 and Proceedings of International Display Workshop '05 (IDW'05), p. 87. The pixels can be combined using, for example, a dither method, an error diffusion method, or other image processing methods.

According to the known method, a pixel can be divided or a plurality of pixels can be used in combination so that a primary color can be mixed with an achromatic color to display, for example, whitish red, dark red, etc. Two primary colors can also be mixed with each other. For example, sky blue can be displayed by mixing blue with green. However, continuous hue, which is necessary for displaying natural images, cannot be provided by the known method.

If a single pixel is divided into a plurality of sub-pixels, the number of driver ICs is increased. In addition, the opening ratio is reduced because the area of regions between the sub-pixels is increased. As a result, the light utilization efficiency is reduced.

US Unexamined Patent Application Publication No. 2006/0055713 describes a structure in which red and blue sub-pixels are used in addition to the magenta sub-pixel 1. Although this structure is advantageous in that analog gradation can be displayed, there is also a problem that the number of color filter processes is increased.

The dither method is based on the principle of color mixture obtained by spatial averaging using a plurality of pixels. Therefore, there is a problem that the resolution is reduced when natural images are displayed.

### SUMMARY OF THE INVENTION

The present invention is directed to a display apparatus and an image forming apparatus which are capable of expressing neutral colors with high resolution and high definition using a simple display panel structure, and which are also capable of accurately presenting an image based on an input image signal.

According to an aspect of the present invention, a display apparatus includes a display panel and a control unit. The display panel includes pixels capable of presenting a display in a range in which brightness varies in accordance with a voltage applied thereto and a range in which hue varies in accordance with the voltage applied thereto. The control unit receives a color image signal and outputs a display signal to the display panel.

The pixels of the display panel include two or more pixels capable of displaying a complementary color selected from yellow, cyan, and magenta, which are obtained by combining two of three primary colors, red, green, and blue. The pixels that display the complementary color are also capable of displaying two of the three primary colors forming the complementary color.

The display apparatus further includes a control unit that controls each pixel of the complementary color in a modulation section A in which the complementary color can be displayed in substantially continuous brightness; a modulation section B in which neutral hue between the complementary color and at least one of the two primary colors forming the complementary color can be displayed and be continuously modulated; and a modulation section C in which neutral hue between one and the other of the two primary colors forming the complementary color can be displayed and be continuously modulated.

If an input signal representing a display color which does not exist on any of the modulation sections A, B, and C is input, colors on different modulation sections are displayed using at least two successive pixels by combining at least two of the three modulation sections.

Two liquid crystal elements can be provided, and the retardation of liquid crystal can be varied in a range including a range in which the hue varies. The liquid crystal elements can be used in combination so that the hue can be continuously modulated in a wide range.

Further features of the present invention will become apparent from the following description of exemplary embodiments with reference to the attached drawings.

### BRIEF DESCRIPTION OF THE DRAWINGS

FIG. 1 illustrates a displayable area according to an embodiment of the present invention.

FIG. 2 illustrates a first partial display area according to the embodiment of the present invention.

FIG. 3 illustrates a second partial display area according to the embodiment of the present invention.

FIG. 4 illustrates a third partial display area according to the embodiment of the present invention.

FIG. 5 illustrates areas that cannot be displayed by the embodiment of the present invention.

FIG. 6 illustrates a displayable area according to an embodiment in which a third pixel is added.

FIG. 7 illustrates color variation of a magenta sub-pixel in a display apparatus according to a first example.

FIG. 8 illustrates the definition of sections according to the first example.

FIG. 9 illustrates a displayable area according to the first example.

FIG. 10 illustrates the distribution of colors of human faces on an RB plane.

FIG. 11 illustrates a displayable area according to a third example.

FIG. 12 illustrates the pixel structure according to a fourth example.

FIG. 13 is a sectional view of an HC-LCD apparatus.

FIG. 14 illustrates a color cube.

FIG. 15 illustrates the relationship between the retardation and the displayed color.

FIG. 16 illustrates a displayable area of a known HC-LCD on the RB plane.

FIG. 17 illustrates the color variation of a magenta sub-pixel with respect to the variation in retardation.

FIG. 18 is a block diagram illustrating the structure of a display apparatus according to a fifth example.

FIG. 19 is a sectional view of a display apparatus according to a sixth example.

### DESCRIPTION OF THE EMBODIMENTS

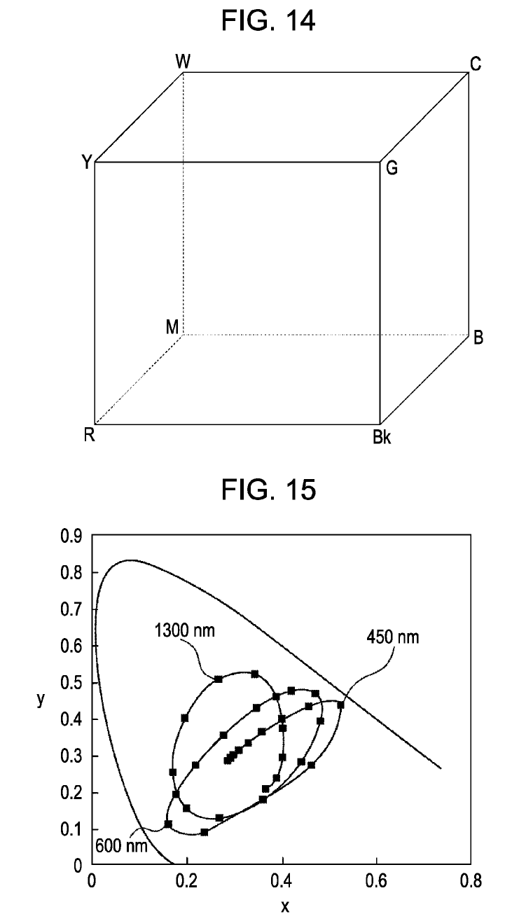

A color to be display can be expressed using a color cube shown in FIG. 14. The color cube has three axes corresponding to the three primary colors of light.

In this specification, the term “color cube” means a cube having black (Bk) at the origin and independent vectors corresponding to red (R), green (G), and blue (B). All colors can be expressed as points in the cube. Each of the colors in the color cube can be expressed as the sum of vectors in the axial directions R, G, and B. Mixed colors can be expressed as vector sums.

Each point in the color cube shows a state of color mixture of red, blue, and green corresponding to the coordinates of the point. Thus, each display color can be expressed as a point represented by a vector extending from the point Bk. The vertex denoted by Bk corresponds to a state in which the brightness is at a minimum, the vertex denoted by W corresponds to a white display state in which the brightness is at a maximum, and the vertices denoted by R, G, and B correspond to the display states of the respective primary colors in which the luminance is at a maximum. Gradation levels of image information signals for red, green, and blue correspond to the coordinates on the respective axes. If each color has 256 gradation levels, the length of each side of the cube is 255.

In a liquid crystal display unit having three color filters for R, G, and B, a single color is expressed by three RGB elements. In this specification, each of the sub-pixels included in a single pixel is called an element or a color element. The three RGB elements form a single unit of color display. Each of the color elements is individually controlled such that the corresponding color can be displayed in continuous gradation. In other words, the magnitudes of three independent vectors forming the color cube can be set to any value between zero and the maximum value.

The magnitudes of the RGB independent vectors are directly and exclusively determined for any color. Therefore, gradation display levels of the sub-pixels having the RGB color filters are determined in accordance with the magnitudes of the vectors. Thus, any color can be displayed as a color mixture of the three sub-pixels.

In an HC-LCD, two sub-pixels (color elements) form a single unit of color display. In the HC-LCD, two color filters are combined such that one of the color filters transmits light of one of the three RGB primary colors and the other color filter transmits light of the other two colors. In the sub-pixel having the color filter that transmits light of a single color, retardation of liquid crystal is varied in a brightness modulation range in response to an application of a voltage. In the sub-pixel having the color filter that transmits light of two colors, the retardation is varied in both a brightness variation range and a hue variation range in response to an application of a voltage. In the following description, the sub-pixel in which the retardation is varied in both the brightness variation range and the hue variation range is called a first color element, and the sub-pixel in which the retardation is varied in the brightness modulation range is called a second color element.

An example of an HC-LCD includes a green sub-pixel and a magenta sub-pixel as a pair of sub-pixels. In the green sub-pixel, the retardation of the liquid crystal is varied in the brightness modulation range so that the brightness of green can be modulated. In the magenta sub-pixel, magenta is displayed when the retardation of the liquid crystal is within the brightness modulation range. When the retardation of the liquid crystal is within the hue modulation range, which is larger than the brightness modulation range, and corresponds to two colors, i.e., red and blue, a color obtained by placing the magenta color filter on the color corresponding to the retardation of the liquid crystal is displayed. In this case, the magenta sub-pixel is the first color element and the green sub-pixels is the second color element.

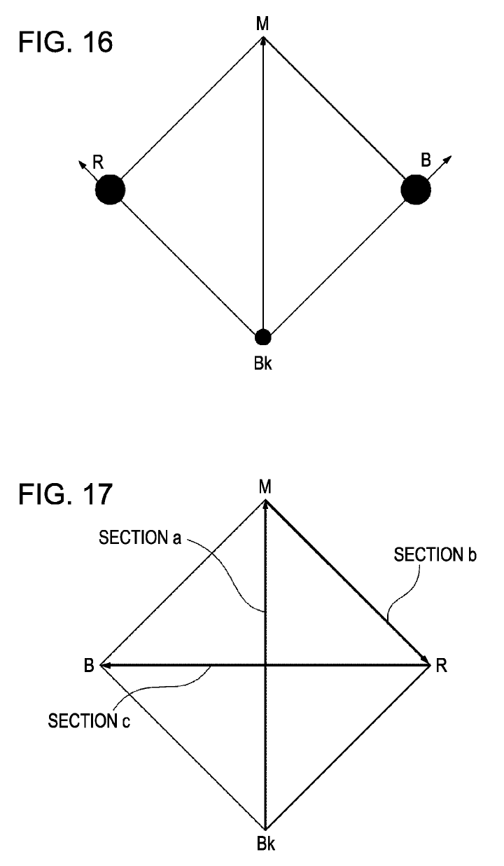

FIG. 15 is a chromaticity diagram showing the relationship between the retardation and color variation caused by birefringence. FIG. 16 illustrates colors that can be displayed by the magenta sub-pixel.

If a voltage is within a range in which the brightness is modulated by the birefringence of the liquid crystal, that is, a brightness modulation section in which the retardation is in the range of 0 nm to 250 nm in FIG. 15, substantially achromatic brightness modulation is performed in the liquid crystal layer. In this range, continuous gradation of magenta, that is, the color of the color filter, can be presented. This can be expressed on an RB plane as a line extending from the origin that represents black to a light magenta (the upward arrow at the center in FIG. 16).

Then, if the voltage is increased, the voltage enters a range in which the hue is varied by the birefringence of the liquid crystal, that is, a hue modulation section in which the retardation is equal to or more than 250 nm in FIG. 15. When the color of light that passes through the liquid crystal layer becomes close to red (around 450 nm) by the birefringence, red is displayed by the subtractive color mixture with magenta, which is the color of the color filter. If the wavelength range of the light that can pass through the color filter is limited to a sufficiently small range, the color purity can be set to a level higher than that of the color obtained by birefringence.

When the amount of birefringence is increased and blue green is displayed by the birefringence at the liquid crystal layer, blue is displayed by the subtractive color mixture with magenta, which is the color of the color filter (around 600 nm).

Red and blue can be expressed as points on the RB plane (left and right vertices of the square shown in FIG. 16). In addition, continuous brightness variation of magenta can also be displayed by the magenta sub-pixel. Thus, colors that can be displayed by the magenta sub-pixel in the HC-LCD can be expressed by a single straight line and two points on the RB plane, as shown in FIG. 16.

Thus, a known HC-LCD uses a magenta brightness modulation section, which connects points of black and magenta, and points representing red and blue are used for display. Since the birefringence is continuously varied in response to continuous variation of the voltage, intermediate hues between magenta and red and between red and blue can also be displayed.

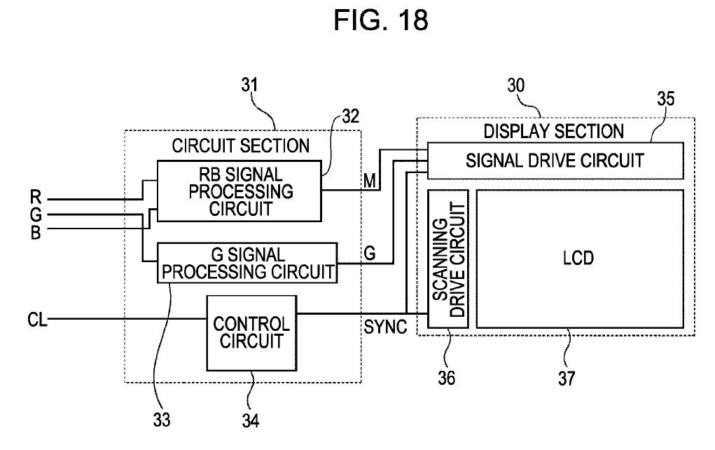

Referring to FIG. 17, the overall variation of color that can be displayed by the magenta sub-pixel is shown as a single locus on the RB plane. The locus represents continuous color variations from magenta to red and from red to blue in addition to the magenta brightness variation between black and magenta. The display color that can be presented by the sub-pixel having the magenta color filter can be expressed by the continuous line on the RB plane of the color cube as shown in FIG. 17. In the following description, the magenta brightness modulation section between black and magenta is called section A, the section in which the color changes from magenta to red is called section B, and the section in which the color changes from red to blue is called section C.

In FIG. 17, the section B is expressed as a straight line extending along a side of the color cube. However, the section B corresponds to a range in which the color is changed from white to yellow, and then to red by the birefringence of the liquid crystal, and the color is not always the mixture of magenta with maximum luminance and red with maximum luminance. Similarly, although the section C is also expressed as a straight line, the section C does not always correspond to the mixture of red with maximum luminance and blue with maximum luminance, nor does it pass through the mid-point of the magenta axis. However, to facilitate the analysis by applying first order approximation, the sections B and C are assumed to be straight lines in the following explanation.

According to an embodiment of the present invention, neutral colors are displayed using first color elements, that is, magenta sub-pixels in this case, in two or more pixels by combining the above-described modulation sections A, B, and C of the first color elements. Thus, continuous gradation can be expressed with a smaller number of pixels compared to the known dither method.

Green sub-pixels, which are the second color elements in this case, are capable of displaying continuous gradation. Therefore, each of the second color elements displays the corresponding color over the entire brightness range.

### First Embodiment

An embodiment of the present invention in which first color elements in two pixels are combined will be described. The first color elements include magenta color filters. The manner in which the color can be continuously varied on the RB plane will be described.

Two magenta sub-pixels 1 in two pixels are used as a pair. The birefringence is continuously controlled in each of the magenta sub-pixels 1 over the sections A, B, and C. It is assumed that a single color is expressed by combining the magenta sub-pixels. Two vectors extending from the origin Bk to two points on the sections A, B, and C can be defined by setting the two points. When the points are moved along the respective sections, an area is defined on the RB plane by adding the two independent vectors. This area shows the range of color that can be displayed by combining the magenta sub-pixels in the two pixels.

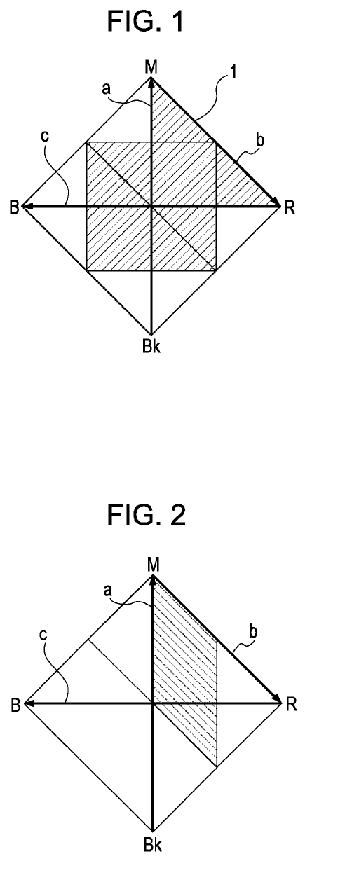

As described in detail below, the above-mentioned area is shown as the shaded area in FIG. 1. Since this area is obtained in place of the combination of a line and points shown in FIG. 16, small differences in the brightness direction and the hue direction can be expressed.

The area defined by the two independent vectors will now be described.

The vector in the red direction is expressed as follows:

\vec{r}

The vector in the blue direction is expressed as follows:

\vec{b}

Thus, the magenta direction can be expressed as follows:

\vec{r}+\vec{b}

A point on the section A can be expressed as follows:

$$s \cdot ( {r}^{->} + {b}^{->} )$$

where s is a value between 0 and 1.

The section B connects magenta and red. Therefore, a point on the section B can be expressed as follows:

$$t \cdot {r}^{->} + ( 1 - t ) \cdot ( {r}^{->} + {b}^{->} )$$

where t is a value between 0 and 1.

The above expression can be rewritten as follows:

\vec{r}+(1−t)·\vec{b}

where t is a value between 0 and 1.

The section C connects red and blue. Therefore, a point on the section C can be expressed as follows:

u·\vec{r}+(1−u)·\vec{b}

where u is a value between 0 and 1.

Here, it is assumed that two magenta sub-pixels having the same area are used. There are six possible combinations of two sections selected from the sections A, B, and C. The six possible combinations are (1) A/A, (2) B/B, (3) C/C, (4) A/B, (5) A/C, and (6) B/C. Color mixtures of the two sub-pixels corresponding to the above mentioned six combinations will now be explained. The mixed color is expressed as the average display color between the two sub-pixels. In the RB plane, the mixed color can be obtained by adding two vectors showing the colors of two sub-pixels and dividing the result by two.

Any point on the straight lines can be set for each of the sub-pixels. Therefore, s, t, and u can be individually selected. A parameter for one of the two sub-pixels is represented by x′ (x is one of s, t, and u), and a parameter for the other one of the two sub-pixels is represented by x″ (x is one of s, t, and u).

If the combination of two sections is (1), two points corresponding to the two sub-pixels are both on the section A. In this case, the average display color of the two sub-pixels can be expressed as follows:

$$\frac{1}{2} \{ {s}^{′} \cdot ( {r}^{->} + {b}^{->} ) + {s}^{″} \cdot ( {r}^{->} + {b}^{->} ) \} = \frac{{s}^{′} + {s}^{″}}{2} ( {r}^{->} + {b}^{->} )$$

where s′ and s″ are values between 0 and 1. Thus, the point representing the average display color is on the magenta vector.

If the combination of the two sections is (2), the average display color can be expressed as follows:

$$\frac{1}{2} \{ \vec{r} + ( 1 - {t}^{′} ) \cdot \vec{b} + \vec{r} + ( 1 - {t}^{″} ) \cdot \vec{b} \} = \vec{r} + ( 1 - \frac{{t}^{′} + {t}^{″}}{2} ) \cdot \vec{b}$$

where t′ and t″ are values between 0 and 1. Thus, the point representing the average display color is on the straight line connecting magenta and red.

If the combination of the two sections is (3), the average display color can be expressed as follows:

$$\frac{1}{2} \{ {u}^{′} \cdot \vec{r} + ( 1 - {u}^{′} ) \cdot \vec{b} + {u}^{″} \cdot \vec{r} + ( 1 - {u}^{″} ) \cdot \vec{b} \} = \frac{{u}^{′} + {u}^{″}}{2} \cdot \vec{r} + \{ 1 - \frac{{u}^{′} + {u}^{″}}{2} \} \cdot \vec{b}$$

where u′ and u″ are values between 0 and 1. Thus, the point representing the average display color is on the straight line connecting red and blue.

If the combination of the two sections is (4), the average display color can be expressed as follows:

$$\frac{1}{2} \{ {s}^{′} \cdot ( \vec{r} + \vec{b} ) + \vec{r} + ( 1 - {t}^{″} ) \cdot \vec{b} \} = \frac{\vec{r} + \vec{b}}{2} \cdot {s}^{′} - \frac{\vec{b}}{2} \cdot {t}^{″} + ( \frac{\vec{r} + \vec{b}}{2} )$$

where s′ and t″ are values between 0 and 1. This expression shows a point in a parallelogram shown in FIG. 2. Thus, the color corresponding to any point in the parallelogram can be displayed by the above combination (4).

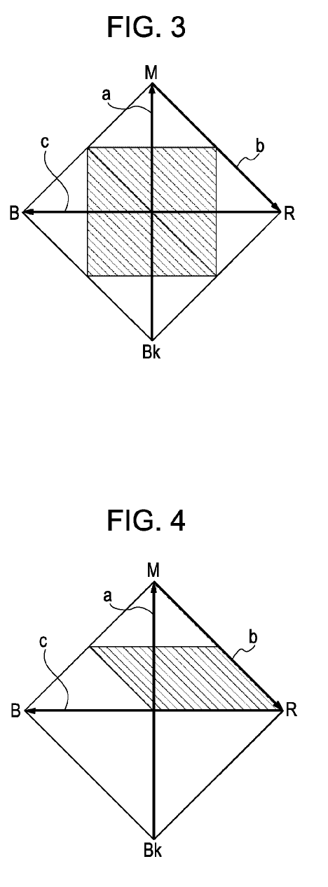

If the combination of the two sections is (5), the average display color can be expressed as follows:

$$\frac{1}{2} \{ {s}^{′} \cdot ( \vec{r} + \vec{b} ) + {u}^{″} \cdot \vec{r} + ( 1 - {u}^{″} ) \cdot \vec{b} \} = \frac{\vec{r} + \vec{b}}{2} \cdot {s}^{′} + \frac{\vec{r} - \vec{b}}{2} \cdot {u}^{″} + \frac{\vec{b}}{2}$$

where s′ and u″ are values between 0 and 1. This expression shows a point in a square shown in FIG. 3. Thus, the color corresponding to any point in the square can be displayed by the above combination (5).

If the combination of the two sections is (6), the average display color can be expressed as follows:

$$\frac{1}{2} \{ \vec{r} + ( 1 - {t}^{′} ) \cdot \vec{b} + {u}^{″} \cdot \vec{r} + ( 1 - {u}^{″} ) \cdot \vec{b} \} = \frac{- \vec{b}}{2} \cdot {t}^{′} + \frac{\vec{r} - \vec{b}}{2} \cdot {u}^{″} + \frac{\vec{r}}{2} + \vec{b}$$

where t′ and u″ are values between 0 and 1. This expression shows a point in a parallelogram shown in FIG. 4. Thus, the color corresponding to any point in the parallelogram can be displayed by the above combination (6).

As a result, the area on the RB plane shown in FIG. 1 can be displayed by the two pixels in accordance with the six combinations.

In the known dither method, when, for example, 4×4 matrix is used, the resolution is reduced to one-fourth in both the vertical and horizontal directions. In addition, only “points” in the color space can be displayed.

In the present embodiment, as described above, two sections selected from the brightness modulation section A and the hue modulation sections B and C are used in combination. As a result, the “area” shown in FIG. 1 can be displayed. According to the known dither method using 4×4=16 pixels, reduction in resolution is √(1/16)=0.25 (0.25 times the resolution obtained when the dither method is not used). In comparison, when two pixels are combined, a large portion of the RB plane becomes displayable. Therefore, reduction in resolution can be reduced to √(1/2)=0.71 (0.71 times the resolution obtained when the dither method is not used).

If, for example, natural images can be displayed at the pixel density of 300 ppi by the known method, the natural images can be displayed at the pixel density of around 100 ppi when the method of the present embodiment is applied.

### Second Embodiment

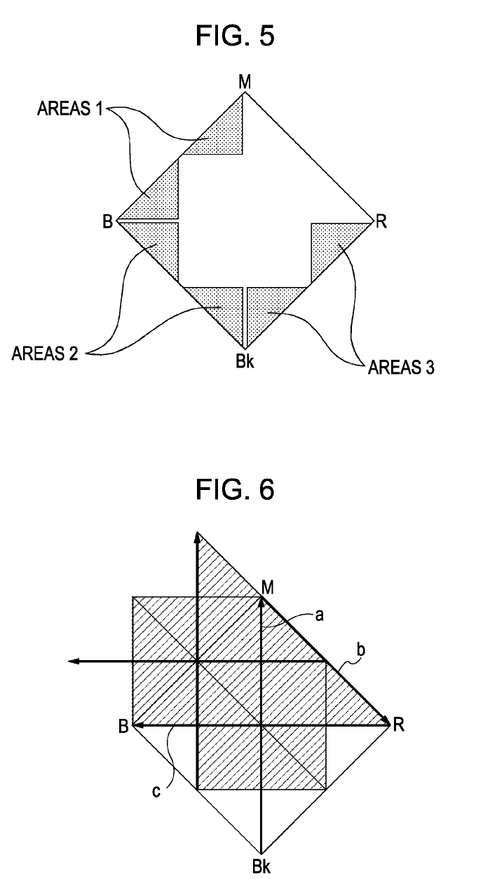

FIG. 5 show areas that cannot be displayed by the method according to the first embodiment in which the color on the RB plane is displayed by combining the first color elements in two pixels. The non-displayable areas can be reduced by combining the first color elements in three pixels. This will be described below.

Areas 1 shown in FIG. 5 can be expressed by displaying blue at the magenta sub-pixel 1 in a third pixel and combining the third pixel with the above-described two pixels. In this case, the displayable area is obtained by shifting the area shown in FIG. 1 by a distance corresponding to the coordinates of the blue display in the third pixel. As a result, the shaded area shown in FIG. 6 is obtained as the displayable area.

However, referring to FIG. 5, areas 2 and 3, which are low-gradation-level areas of colors close to primary colors red and blue, still cannot be displayed. These non-displayable areas can be reduced, as described below in the examples, due to the fact that the sections A, B, and C are not linear but curved in accordance with the optical characteristics of the liquid crystal.

The above-described method for displaying continuous gradation using the combination of two, three or more pixels can be used in combination with a method of dividing a single magenta pixel into a plurality of sub pixels at an area ratio of, for example, 2:1. If it is expected that the existence of the non-displayable area will cause a problem, the non-displayable area can be reduced by using a plurality of sub-pixels.

### EXAMPLES

Examples of the present invention will be described in detail below.

### First Example

A 12-inch diagonal active-matrix liquid crystal display panel having 600×800 pixels was used. The pixel pitch was about 300 μm. Each pixel was divided into two halves in which green and magenta color filters were disposed. The thickness of a liquid crystal layer was adjusted to 5 μm so that the sub-pixel having the magenta color filter displays blue when a voltage of ±5 V is applied.

FIG. 13 is a sectional view illustrating the cell structure of an HC-LCD.

A display apparatus 100 has a layered structure including a polarizing plate 10, a retardation plate 20, and a liquid crystal panel 90. A lower substrate 7 included in the liquid crystal panel 90 has TFT drive circuits (not shown) arranged thereon in a matrix pattern. The lower substrate 7 functions as an active matrix substrate on which a pixel electrode 6 is provided for each sub-pixel. A cell is formed by bonding a counter substrate 3 to the lower substrate 7. The counter substrate 3 has a magenta color filter 81, a green color filter 82, and a transparent electrode 4. Vertical alignment films (not shown) are applied to the surfaces of the electrodes 4 and 6, and a pre-tilt angle, which is an angle with respect to a direction perpendicular to the substrates, is set to about 1 degree by a rubbing process. A liquid crystal material (product code MLC-6608 manufactured by Merck & Co., Inc.) having a negative dielectric anisotropy Δε can be used as liquid crystal 5. The liquid crystal 5 is injected into a space between the substrates 3 and 7.

The liquid crystal 5 is oriented substantially vertically with respect to the substrate surfaces when no voltage is applied to the electrodes 4 and 6. When a voltage is applied, the liquid crystal molecules are inclined with respect to the substrates. Retardation is determined by the inclination angle of the liquid crystal molecules. The polarizing plate 10 is arranged such that the angle between the inclination direction of the liquid crystal and the absorption axis is about 45 degrees.

Thus, the HC-LCD is structured such that the color filter is disposed on the liquid crystal layer that changes the retardation. The pixel electrodes 6 are formed of aluminum electrodes so that the HC-LCD functions as a reflective liquid crystal display.

A broadband λ/4 plate (a phase compensation plate that substantially completely satisfies the ¼ wavelength condition in the visible range) is disposed as a phase compensation plate between the counter substrate 3 and the polarizing plate 10. Thus, a normally black structure is obtained in which the reflective display is set to a dark state when no voltage is applied and to a light state when a voltage is applied.

In a single pixel of the above-described display apparatus, green and magenta are displayed in continuous gradation whereas red and blue are displayed in a binary manner. If a natural image is displayed by the known dither method, the displayed image has granular quality and smooth gradation cannot be expressed.

A voltage can be applied such that the display apparatus displays a single color over the entire panel area, and then be varied to display an image. If a uniform voltage is applied to all of the magenta sub-pixels and the voltage is gradually increased while the green-pixels continuously display black, the color of the screen changes from black to light magenta. Then, if the voltage is further increased, the hue is continuously changed from magenta to red, dark magenta, and blue in that order.

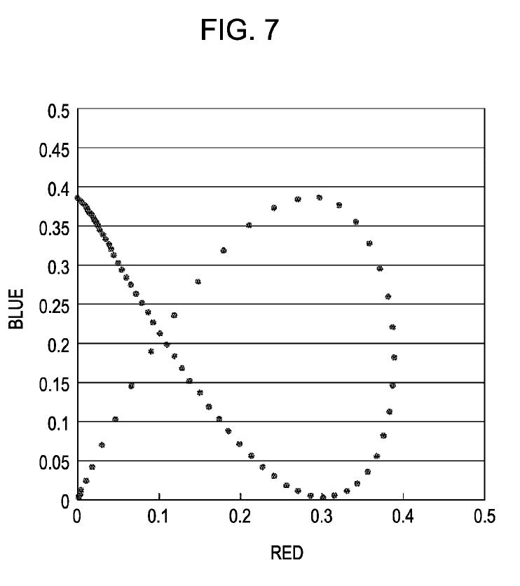

It is assumed that the light source emits light such that components of three wavelengths, that is, B=450 nm, G=550 nm, and R=650 nm, are at the same luminance. FIG. 7 shows the calculation result of variation in the brightness of R and B in accordance with the retardation. The brightness is gradually increased for both colors as the retardation is increased from 0 to 250 nm. Accordingly, the transmittance is increased in the substantially achromatic state. When the retardation is more than 250 nm, the transmittance differs between the two colors and a chromatic state is established.

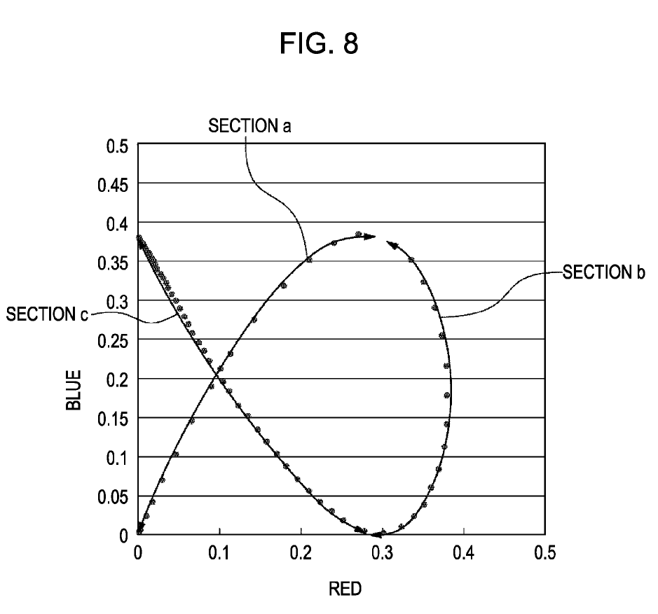

Thus, in practice, the color is varied along curved lines instead of straight lines on the RB plane. Therefore, referring to FIG. 8, modulation sections A to C are re-defined as follows.

1. A modulation section A between black (origin) and a color close to the mixture of two colors (position near the coordinates (1,1) on the graph).

2. A modulation section B between the color close to the mixture of two colors (position near the coordinates (1,1) on the graph) and a color close to one of the primary colors (position near the coordinates (1,0) or (0,1) on the graph).

3. A modulation section C between the color close to one of the primary colors (position near the coordinates (1,0) or (0,1) on the graph) and a color close to the other one of the primary colors (position near the coordinates (0,1) or (1,0) on the graph).

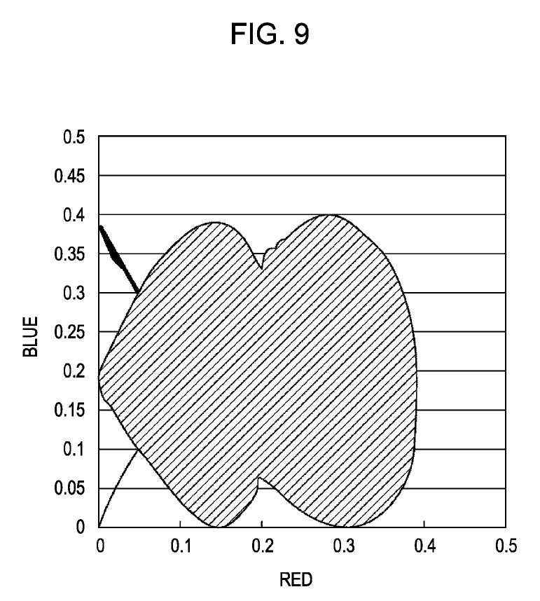

If magenta sub-pixels in two adjacent pixels are individually controlled in the manner shown in FIG. 7, FIG. 9 can be obtained by plotting the average color of the two sub-pixels on the RB plane. The displayable area shown as the shaded region in FIG. 9 covers about 80% of the RB plane.

### Second Example

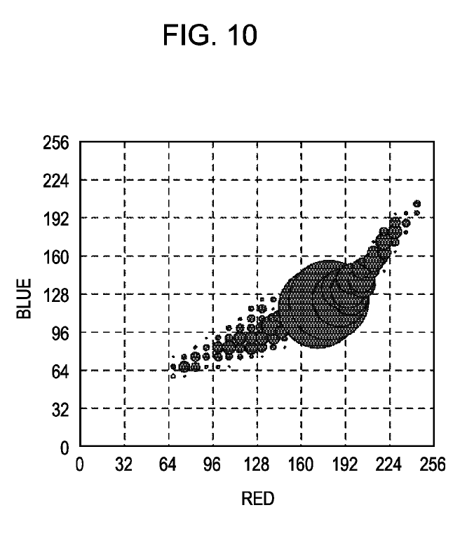

An accurate gradation reproduction is required to display the color of human skin. FIG. 10 shows the result of analysis performed by the inventors regarding images having the color of human skin. FIG. 10 is obtained by plotting skin colors extracted from portrait images of many people on the RB plane. It is clear from the analysis result of the images having skin colors that human skin colors are in an area shifted from the diagonal (magenta) axis toward the red axis on the RB plane.

This area is within the area shown in FIG. 1 that can be displayed by the method according to the embodiments of the present invention. Therefore, the method according to the embodiments of the present invention is suitable for displaying human faces and bodies.

According to the embodiments of the present invention, two magenta sub-pixels in the two pixels that are adjacent to each other in the horizontal direction are used as a pair. Therefore, the resolution is reduced to a half in the horizontal direction. However, the reduction in resolution is almost indiscernible when portrait images or natural images are displayed. Therefore, human faces can be displayed in natural colors and smooth gradation.

### Third Example

In this example, a 12-inch diagonal active-matrix display panel having 600×800 pixels was used. The pixel pitch was 300 μm, and a sub-pixel having a magenta color filter was divided into two sub-pixels at an area ratio of 1:2. The area ratio between a green sub-pixel and the two magenta sub-pixels was 3:1:2. The thickness of a liquid crystal layer was adjusted to 5 μm so that the sub-pixels having the magenta color filter display blue when a voltage of ±5 V is applied.

The cross-sectional cell structure according to the third example was similar to that of the first example. In the liquid crystal display unit of the third example, green and magenta can be displayed in continuous gradation and red and blue can be displayed in four gradation levels.

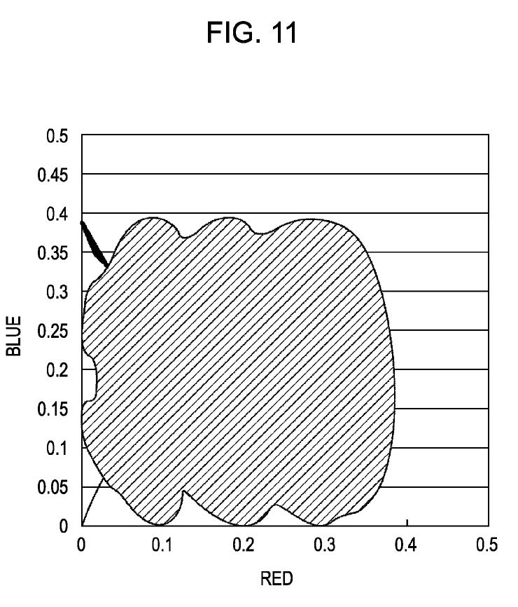

FIG. 11 is obtained by plotting the average color of the two pixels on the RB plane. Since the magenta sub-pixel is divided into two sub-pixels so that red and blue can be displayed in four gradation levels, the displayable area shown in FIG. 11 covers 90% of the RB plane.

Although non-displayable areas still remain, if an image signal representing a color in the non-displayable areas is input, mapping can be performed so that an image signal representing the closest color can be output. Color differences are hardly discernible in low-gradation-level areas. In addition, although colors in middle-gradation-level areas and high-gradation-level areas near the R and B axes are somewhat shifted toward magenta, the amount of shift is small. Therefore, the observed image does not largely differ from the original image.

### Fourth Example

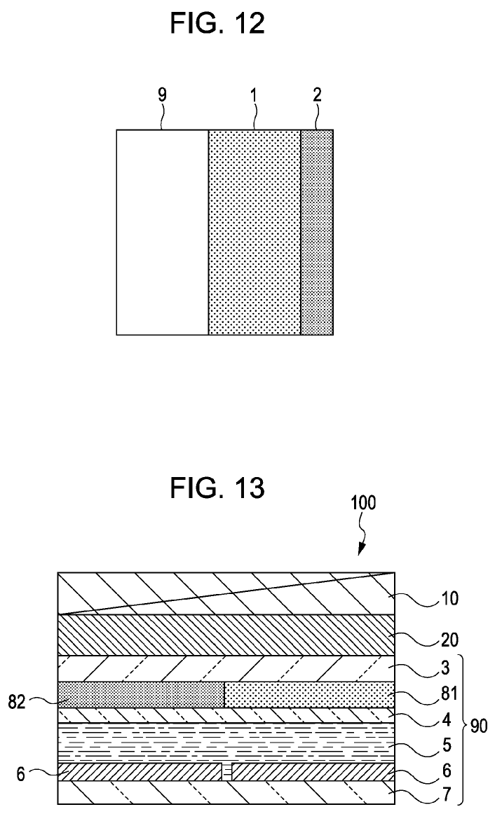

FIG. 12 shows a plan view of a pixel according to a fourth example. The pixel of the fourth example includes a sub-pixel 2 having a green color filter, a sub-pixel 1 having a magenta color filter, and a transparent sub-pixel 9. Other structures of a liquid crystal panel according to the fourth example are similar to those of the third example.

The transparent sub-pixel 9 is used as a third color element and is operated so as to display blue by applying a voltage of ±5 V. The magenta sub-pixel 1, which is a first color element, is driven in a manner similar to that in the first example, and neutral colors are displayed by combining two pixels. The green sub-pixel 2, which is a second color element, is operated such that the brightness thereof is individually modulated in each pixel.

Thus, the area shown in FIG. 6 can be displayed. More specifically, the area between light magenta and blue can be displayed. As a result, colors in light blue area, such as highlighted violet and sky blue obtained as a mixture of blue and green, can be smoothly displayed.

### Fifth Example

FIG. 18 is a block diagram of a display apparatus according to an embodiment of the present invention. The display apparatus includes a display section 30 and a circuit section 31.

The display section 30 includes a liquid crystal panel 37 identical to that of the first example, a scanning drive circuit 36, and a signal drive circuit 35.

The circuit section 31 receives image signals R, G, and B and outputs voltage signals M and G to the display panel. The image signals are parallel signals corresponding to the three RGB colors and form a single unit of color display. The image signals are transmitted in time series in units of color display. A single unit of color display represents a single point in the color cube.

In addition to the RGB image signals, a synchronization signal CL is input to a control circuit 34 included in the circuit section 31. The synchronization signal CL is converted into a display control signal SYNC by the control circuit 34, and the display control signal SYNC is transmitted to the scanning drive circuit 36 and the signal drive circuit 35 in the display section 30. Thus, the display operation is controlled.

The G signal is converted into a voltage signal by a G-signal processing circuit 33, and the thus-obtained voltage signal is transmitted to the signal drive circuit 35 of the display panel as the signal G for a green sub-pixel. The signal conversion can be performed by a known method, and the G signal processing circuit 33 includes circuits for DA conversion, gamma correction, etc.

The R and B signals are converted into voltage signals for magenta sub-pixels by an RB signal processing circuit 32 as follows.

That is, when the R and B signals are input, the circuit converts the input signals into signals for two magenta sub-pixels included in two adjacent pixels (hereinafter denoted by P and Q). The input signals can be expressed by a single vector InputData (R, B) on the RB plane. InputData (R, B) can be expressed as the sum of two vectors at the sections A, B, and C, and signals representing the two vectors can be output as the signals for the pixels P and Q. A method for determining the two vectors will now be described.

As described in the first embodiment, the parameter x′ of one of the two sub-pixels is one of s′, t′, and u′, each of which varies in the range of 0 to 1, for the sections A, B, and C, respectively. The parameter x″ of the other one of the two sub-pixels is one of s″, t″, and u″, each of which varies in the range of 0 to 1, for the sections A, B, and C, respectively.

(1) If the point represented by the R and B input signals is in the area shown in FIG. 2, InputData (R, B) can be expressed as the sum of two vectors at the sections A and B as follows:

$$InputData ( R , B ) = \frac{{s}^{′}}{2} \cdot ( \vec{r} + \vec{b} ) - \frac{{t}^{″}}{2} \cdot \vec{b} + ( \frac{\vec{r} + \vec{b}}{2} ) .$$

The above expression can be rewritten using the unit vectors (255, 0) and (0, 255) as follows:

$$InputData ( R , B ) = \frac{{s}^{′}}{2} \cdot ( ( 255 , 0 ) + ( 0 , 255 ) ) - \frac{{t}^{″}}{2} \cdot ( 0 , 255 ) + ( \frac{( 255 , 0 ) + ( 0 , 255 )}{2} )$$

Thus, R and B can be obtained as follows:

$$R = \frac{{s}^{′}}{2} \cdot 255 + \frac{255}{2}$$

$$B = \frac{{s}^{′}}{2} \cdot 255 - \frac{{t}^{″}}{2} \cdot 255 + \frac{255}{2} .$$

When the above equations are solved for s′ and t″, the following solution can be obtained:

$$( \begin{matrix}{s}^{′} \\ {t}^{″}\end{matrix} ) = ( \begin{matrix}\frac{2 R - 255}{255} \\ \frac{2 R - 2 B}{255}\end{matrix} ) .$$

The above expression shows the voltage signals for the magenta sub-pixels in the pixels P and Q.

In the above equation, s′ and t″ can be set for the P pixel and the Q pixel, respectively, or vice versa. The combination can be alternately reversed in each frame to prevent unbalanced display between the P and Q pixels.

(2) If the point represented by the input signals is in the area shown in FIG. 3, InputData (R, B) can be expressed as the sum of two vectors at the sections A and C as follows:

$$InputData ( R , B ) = \frac{{s}^{′}}{2} \cdot ( \vec{r} + \vec{b} ) + \frac{{u}^{″}}{2} \cdot ( \vec{r} - \vec{b} ) + \frac{\vec{b}}{2}$$

The above expression can be rewritten by inputting the coordinate values as follows:

$$InputData ( R , B ) = \frac{{s}^{′}}{2} \cdot [ ( 255 , 0 ) + ( 0 , 255 ) ] + \frac{{u}^{″}}{2} \cdot [ ( 255 , 0 ) - ( 0 , 255 ) ] + \frac{( 0 , 255 )}{2}$$

Thus, R and B can be obtained as follows:

$$R = \frac{{s}^{′}}{2} \cdot 255 + \frac{{u}^{″}}{2} \cdot 255$$

$$B = \frac{{s}^{′}}{2} \cdot 255 - \frac{{u}^{″}}{2} \cdot 255 + \frac{255}{2} .$$

When the above equations are solved for s′ and u″, the following solution can be obtained:

$$( \begin{matrix}{s}^{′} \\ {u}^{″}\end{matrix} ) = ( \begin{matrix}\frac{R}{255} + \frac{B - 255 / 2}{255} \\ \frac{R}{255} - \frac{B - 255 / 2}{255}\end{matrix} )$$

The above expression shows the voltage signals for the magenta sub-pixels in the pixels P and Q.

(3) If the point represented by the input signals is in the area shown in FIG. 4, InputData (R, B) can be expressed as the sum of two vectors at the sections B and C as follows:

$$InputData ( R , B ) = \frac{{t}^{′}}{2} \cdot ( - \vec{b} ) + \frac{{u}^{″}}{2} \cdot ( \vec{r} - \vec{b} ) + \frac{\vec{r}}{2} + \vec{b} .$$

Thus, the following expression can be obtained by similar calculations:

$$( \begin{matrix}{t}^{′} \\ {u}^{″}\end{matrix} ) = ( \begin{matrix}\frac{- 2 R - 2 B + 510}{255} \\ \frac{2 R - 255}{255}\end{matrix} )$$

The above expression shows the voltage signals for the magenta sub-pixels in the pixels P and Q.

The point represented by the input signals can be in two or three of the areas shown in FIGS. 2 to 4 at the same time (for example, (R, B)=(140, 128)). In such a case, the above-described parameters have two or three solutions, and cannot be determined directly and exclusively. Therefore, the solutions can be evenly assigned to multiple pairs of two pixels. For example, if two solutions are obtained, the pairs of adjacent pixels (P, Q) can be divided into two groups in a checkerboard pattern, and the first and second solutions can be respectively used for one and the other of the two groups. If three solutions are obtained, the pairs of adjacent pixels (P, Q) can be divided into three groups in a delta pattern and the first, second, and third solutions can be respectively used for the three groups. If the point represented by the input signals is in only one of the areas shown in FIGS. 2 to 4, the parameters have only one solution.

Thus, the R and B image signals are converted into the signals for the magenta sub-pixels in the two pixels. Then, the thus-obtained signals are converted into voltage signals M for the respective magenta sub-pixels by a known method similar to the method used by the G signal processing circuit 33. Then, the voltage signals M are transmitted to the signal drive circuit 35 of the display panel.

As a result, a single set of color image signals are converted into the voltage signal G for a single pixel and the voltage signals M for two pixels. A single pixel serves as a single display unit when green is displayed, and two pixels form a single display unit when red or blue is displayed. Since red and blue are displayed using two pixels, every other image signal input in time series is used as the display signal, and the other signals are not used.

In this example, magenta sub-pixels in the adjacent pixels are used to display colors in continuous modulation sections, and a mixture of the colors is presented. Thus, smooth, natural images can be displayed.

### Sixth Example

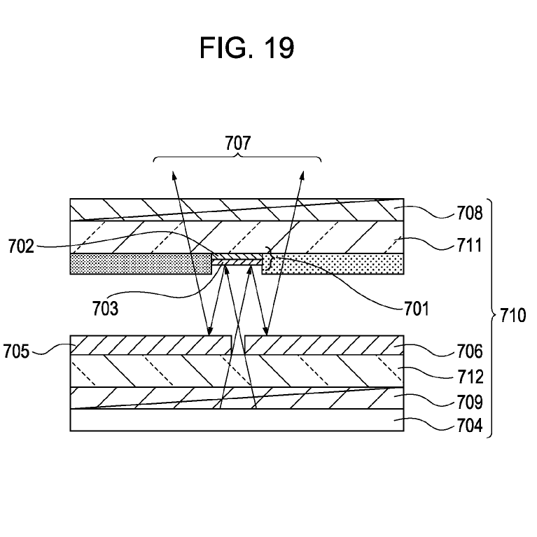

In a sixth example, a liquid crystal device 710 shown in FIG. 19 is used. The liquid crystal device 710 has a structure similar to that of the liquid crystal panel according to first to fifth examples except a black matrix 701 is provided between the pixels. The liquid crystal device 710 includes a reflective electrode substrate 712 having thin-film transistors (not shown) provided thereon and a substrate 711 facing the reflective electrode substrate 712 and having color filters (not shown) provided thereon. The liquid crystal element 710 also includes aligning films and a liquid crystal layer, which are not shown in FIG. 19.

The black matrix 701 according to the sixth example is a commonly used black matrix made of chrome, and is manufactured by forming a chromium oxide layer 702 and a metal chrome layer 703 in that order on a glass substrate and then forming a pattern of the matrix. If the black matrix 701 is used in an LCD panel, the black matrix 701 is shown in black when viewed from the glass substrate because the chromium oxide can be seen through the glass substrate. If the black matrix is viewed from the opposite side, metallic luster of the metal chrome can be observed.

If a backlight 704 is disposed behind the liquid crystal element 710 and is turned on, light from the backlight 704 passes through a gap between two reflective pixels 705 and 706 that are adjacent to each other. The light is reflected by the metal chrome, reaches the aluminum reflective electrode, and is reflected by the aluminum reflective electrode so that the reflected light can be observed. The paths of light in this case are shown by the arrows 707.

The amount of light that reaches the aluminum reflective electrode can be controlled by placing particles on the metal chrome layer to increase the diffusion of light or by forming the metal chrome layer such that the metal chrome layer has an irregular surface.

A known front diffusion plate can be disposed between the glass substrates 711 and 708. In such a case, a light-quantity adjusting function can be obtained by diffusion using a common member between a reflective mode and a transmissive mode.

A liquid crystal mode according to the present example uses vertical alignment. Therefore, birefringence modulation does not occur when light from the backlight passes through the gap between the pixels. More specifically, when the light is reflected by the metal chrome layer, circular polarization set by the backlight and a circularly polarizing plate is maintained. Thus, the reflected light is equivalent to light that passes through a circularly polarizing plate on the front. As a result, a transflective liquid crystal element with high reflectivity, that is, a so-called visible everywhere transflective type liquid crystal element, can be obtained without largely changing the structure of the reflective LCD.

If a display mode other than the vertical alignment mode is used in which birefringence occurs when no voltage is applied, an optical film for compensating for the birefringence between the pixels can be disposed between the substrate 712 near the backlight 704 and the polarizing plate 709. Thus, an effect similar to the effect obtained in the vertical alignment mode can be obtained.

In this example, similar to the first to fifth examples, a broadband circularly polarizing plate 708 is provided on the front side of the panel, and a polarizing plate 709 is disposed on the back side of the panel such that an optical axis of the polarizing plate 709 extends perpendicular to that of the polarizing plate 708 on the front side.

As a result, the display can be observed even in a dark place where no external light is available. At this time, light leakage that easily occurs in the structure having a front light when the display is viewed from an oblique angle can be prevented. In addition, good display characteristics with smooth gradation characteristics similar to those of normal LCDs can be obtained.

The above-described transflective structure can be advantageously applied to the apparatuses according to the embodiments of the present invention in view of viewing angle characteristics. As described above, the area shown in FIG. 1 can be displayed in continuous gradation, so that natural images, such as images of human faces, can be displayed. However, if, for example, an image includes a region where the color continuously changes across the boundary between the area shown in FIG. 2 and the area shown in FIG. 3, the molecular inclination angle (alignment) suddenly changes at the boundary between the areas shown in FIGS. 2 and 3. An example of such an image is an image with 256 gradation levels including a region where the gradation data is continuously changed from (R, B)=(140, 110) to (R, B)=(110, 110). In such an image, even if the display color obtained as a result of the additive color mixture is continuously changed, the color is discontinuously changed at the boundary in each pixel. As a result, when the image is viewed from different viewing angles, discontinuous variation in gradation is observed if the structure for compensation of the viewing angle is not adequately designed in the liquid crystal panel.

In the above-described examples, a vertical alignment mode liquid crystal display unit is mainly explained. However, the present invention can also be applied to liquid crystal display units of other modes, such as parallel alignment mode, HAN mode, OCB mode, etc., as long as variation in retardation caused by the application of voltage is used. In addition, the present invention can also be applied to liquid crystal modes, such as STN mode, in which the liquid crystal is in the twisted alignment.

In addition to liquid crystal, the present invention can also be applied to solid electro-optical materials, such as barium titanate (BaTi₃), and electro-optical elements that cause birefringence and change retardation when a voltage is applied.

In the above-described examples, color elements having green and magenta color filters are described. In general, in the HC-LCD, combinations of color filters are set such that one of the color filters transmits light of one of the three RGB primary colors and the other color filter transmits light of the other two colors. The present invention can also be applied to structures in which a cyan color filter that transmits B light and G light or a yellow color filter that transmits R light and G light is used in place of the magenta color filter that transmits R light and B light. However, in such a case, the retardation does not continuously vary between the brightness variation range and the hue variation range, and the sections A, B, and C are not connected to each other as shown in FIGS. 7 and 17.

A sub-pixel having a red or blue color filter may also be used instead of the sub-pixel having the green color filter that displays green in the brightness variation range. Thus, the present invention can also be applied to the pixel structure including red and cyan sub-pixels or blue and yellow sub-pixels.

In the semitransparent structure according to the above-described example, the light passes through the liquid crystal layer along a constant path in the transmissive section. In other words, the structure for displaying a certain gradation level irrespective of the observation position can be easily designed. Thus, the above-described problem of dependency on the viewing angle does not occur and smooth gradation can be displayed.

In addition to the above-described advantage that the image quality can be increased, according to the semitransparent structure of the above-described example, a multi-gap structure (cell structure in which a plurality of areas having different thicknesses are provide in each pixel), which is used in common transflective LCDs, is not required in the transflective structure according to the present embodiment. Therefore, the costs can be reduced.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-137947 filed May 24, 2007, which is hereby incorporated by reference herein in its entirety.

What is claimed is:

1. A color display apparatus comprising:
a plurality of color elements, each color element including an electro-optical element in which retardation varies in accordance with a voltage applied to the electro-optical element and a color filter provided on the electro-optical element,
wherein the color elements include two or more first color elements in which the color filters transmit light of two of three primary colors, each first color element receiving a voltage that continuously varies the retardation of the electro-optical element in a range in which brightness of the first color element varies and a range which starts from the retardation corresponding to the maximum brightness and in which hue of the first color element varies between the two of the three primary colors, and
wherein the two or more first color elements function as a unit of color display for the two of the three primary colors.

2. The color display apparatus according to claim 1, wherein the color filters that transmit light of the two of the three primary colors transmit red light and blue light.

3. The color display apparatus according to claim 1, wherein the color elements further include a second color element in which the color filter transmits light of the remaining one of the three primary colors, the second color element receiving a voltage that continuously varies the retardation of the electro-optical element in a range in which brightness of the second color element varies, and
wherein the second color element functions as a unit of color display for the remaining one of the three primary colors.

4. The color display apparatus according to claim 3, wherein the color filters that transmit light of the two of the three primary colors transmit red light and blue light, and the color filter that transmits light of the remaining one of the three primary colors transmits green light.

5. The color display apparatus according to claim 1, further comprising:
a third color element including an electro-optical element in which retardation varies in accordance with a voltage applied to the third electro-optical element, the third color element being free from a color filter.

6. A color display apparatus comprising:
a display panel including a plurality of color elements, each color element including an electro-optical element in which retardation varies in accordance with a voltage applied to the electro-optical element and a color filter provided on the electro-optical element; and
a circuit that receives color image signals corresponding to three primary colors and converts the color image signals into voltage signals to be supplied to the electro-optical elements,
wherein the color elements of the display panel include two or more first color elements in which the color filters transmit light of two of the three primary colors and a second color element in which the color filter transmits light of the remaining one of the three primary colors, each first color element receiving a voltage that continuously varies the retardation of the electro-optical element in a range in which brightness of the first color element varies and a range which starts from the retardation corresponding to the maximum brightness and in which hue of the first color element varies between the two of the three primary colors, the second color element receiving a voltage that continuously varies the retardation of the electro-optical element in a range in which brightness of the second color element varies, and
wherein, the color image signals corresponding to the two of the three primary colors are converted by the circuit into voltage signals to be supplied to the electro-optical elements in the two or more first color elements, and the color image signal corresponding to the remaining one of the three primary colors is converted by the circuit into a voltage signal to be supplied to the electro-optical element in the second color element.
